(19) United States
(12) Patent Application Publication
(10) Pub. No.: US 2019/0322210 A1
(43) Pub. Date: Oct. 24, 2019

(54) APPARATUS AND METHOD FOR NOTIFYING EXPECTED MOTION OF VEHICLE

(71) Applicant: WeRide Corp., Sunnyvale, CA (US)

(72) Inventors: Xu HAN, Sunnyvale, CA (US); Miao SUN, Sunnyvale, CA (US); Yan LI, Sunnyvale, CA (US)

(21) Appl. No.: 16/392,642

(22) Filed: Apr. 24, 2019

Related U.S. Application Data
(60) Provisional application No. 62/661,657, filed on Apr. 24, 2018.

(51) Int. Cl. B60Q 1/34; B60Q 1/26; B60Q 1/00

(52) U.S. Cl. CPC B60Q 1/346; B60Q 1/2696; B60Q 1/488; B60Q 1/2619; B60Q 1/0023

(57) ABSTRACT

An apparatus and a method for method and an apparatus for notifying an expected motion of a vehicle are provided. The apparatus includes: a light projection module disposed on a body of the vehicle and operable to project a visual light pattern to an external environment in which the vehicle is driving; and a processor configured to: obtain trajectory information indicative of an expected motion of the vehicle; and generate, according to the trajectory information, and transmit to the light projection module a projection control signal for controlling the light projection module to project the visual light pattern onto a surface in the external environment such that the expected motion of the vehicle can be visually observed from the external environment.

### CROSS-REFERENCE TO RELATED APPLICATIONS

The present application claims the benefit of U.S. provisional patent application 62/661,657, filed Apr. 24, 2018, the disclosure of which is incorporated herein by reference in the entirety.

### TECHNICAL FIELD

The present disclosure generally relates to automotive technology, more particularly, to an apparatus and a method for notifying an expected motion of a vehicle.

### BACKGROUND

Autonomous driving is a relatively new technological field for automotive industry. With autonomous driving, vehicles are capable of sensing their environment and navigating without human operations. Autonomous cars use a variety of technologies to detect their surroundings, such as using radar, laser, GPS, odometry and computer vision. Advanced control systems of Autonomous vehicles can interpret sensory data to identify appropriate navigation paths, as well as obstacles and relevant signages.

Although autonomous vehicles have already driven millions of miles on public roads, the road safety is still a main concern. Thus, there is a need for further improvement.

### SUMMARY

According to a first aspect of embodiments of the present disclosure, an apparatus for notifying an expected motion of a vehicle is provided. The apparatus may include: a light projection module disposed on a body of the vehicle and operable to project a visual light pattern to an external environment in which the vehicle is driving; and a processor configured to: obtain trajectory information indicative of an expected motion of the vehicle; and generate, according to the trajectory information, and transmit to the light projection module a projection control signal for controlling the light projection module to project the visual light pattern onto a surface in the external environment such that the expected motion of the vehicle can be visually observed from the external environment.

According to a second aspect of embodiments of the present disclosure, a vehicle is provided. The vehicle may include: a body; a light projection module disposed on the body of the vehicle and operable to project a visual light pattern onto an external environment in which the vehicle is driving; and a processor configured to: obtain trajectory information indicative of an expected motion of the vehicle; and generate, according to the trajectory information, a projection control signal for controlling the light projection module to project the visual light pattern onto a surface in the external environment such that the expected motion of the vehicle can be visually observed from the external environment.

According to a third aspect of embodiments of the present disclosure, a method for notifying an expected motion of a vehicle is provided. The method may include: obtaining trajectory information indicative of an expected motion of the vehicle; and generating, according to the trajectory information, and transmitting to the light projection module a projection control signal for controlling a light projection module to project a visual light pattern onto a surface in an external environment in which the vehicle is driving such that the expected motion of the vehicle can be visually observed from the external environment.

It is to be understood that both the foregoing general description and the following detailed description are exemplary and explanatory only, and are not restrictive of the invention. Further, the accompanying drawings, which are incorporated in and constitute a part of this specification, illustrate embodiments of the invention and together with the description, serve to explain principles of the invention.

### BRIEF DESCRIPTION OF THE DRAWINGS

The drawings referenced herein form a part of the specification. Features shown in the drawing illustrate only some embodiments of the disclosure, and not of all embodiments of the disclosure, unless the detailed description explicitly indicates otherwise, and readers of the specification should not make implications to the contrary.

FIG. 1 illustrates a block diagram of an apparatus for notifying an expected motion of a vehicle according to one embodiment of the present disclosure;

FIG. 2 illustrates a vehicle equipped with the apparatus of FIG. 1;

FIG. 3 illustrates a flow chart of a method for notifying an expected motion of a vehicle according to one embodiment of the present disclosure;

FIGS. 4 (a) and (b) illustrate examples of a visual light pattern projected onto a surface in the external environment of the vehicle;

FIG. 5 illustrates another example of the visual light pattern projected onto a surface in the external environment of the vehicle;

FIG. 6 illustrates another example of the visual light pattern projected onto a surface in the external environment of the vehicle;

FIG. 7 illustrates another example of the visual light pattern projected onto a surface in the external environment of the vehicle; and

FIG. 8 (a)-(d) illustrate various examples of the visual light pattern projected onto a surface in the external environment of the vehicle.

The same reference numbers will be used throughout the drawings to refer to the same or like parts.

### DETAILED DESCRIPTION OF THE PREFERRED EMBODIMENTS

The following detailed description of exemplary embodiments of the disclosure refers to the accompanying drawings that form a part of the description. The drawings illustrate specific exemplary embodiments in which the disclosure may be practiced. The detailed description, including the drawings, describes these embodiments in sufficient detail to enable those skilled in the art to practice the disclosure. Those skilled in the art may further utilize other embodiments of the disclosure, and make logical, mechanical, and other changes without departing from the spirit or scope of the disclosure. Readers of the following detailed description should, therefore, not interpret the description in a limiting sense, and only the appended claims define the scope of the embodiment of the disclosure.

In this application, the use of the singular includes the plural unless specifically stated otherwise. In this application, the use of “or” means “and/or” unless stated otherwise. Furthermore, the use of the term “including” as well as other forms such as “includes” and “included” is not limiting. In addition, terms such as “element” or “component” encompass both elements and components comprising one unit, and elements and components that comprise more than one subunit, unless specifically stated otherwise. Additionally, the section headings used herein are for organizational purposes only, and are not to be construed as limiting the subject matter described.

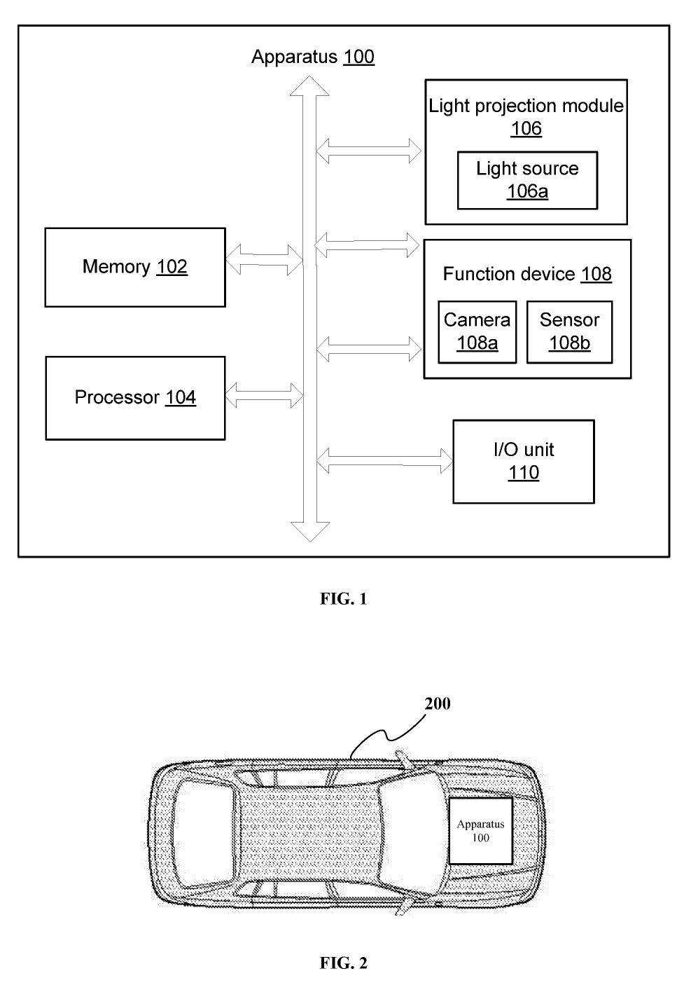

FIG. 1 illustrates a block diagram of an apparatus 100 according to an embodiment of the present disclosure. The apparatus 100 may be disposed on a vehicle for notifying people around of an expected motion of the vehicle. In some embodiments, the vehicle may be an autonomous vehicle. It could be appreciated that the apparatus 100 can also be disposed on a regular non-autonomous vehicle.

As depicted in FIG. 1, the apparatus 100 includes a memory 102, a processor 104, a light projection module 106, a function device 108 and an input and output (I/O) unit 110. The memory 102, the processor 104, the light projection module 106, the function device 108 and the I/O unit 110 are directly or indirectly connected with each other for data and signal transmission or exchange. For example, these components may be electrically connected to each other via one or more communication buses or signal lines.

The apparatus 100 may include at least one program function module in form of software or firmware stored or embedded in the memory 102 and executed by the processor 104. The processor 104 is used for performing executable instructions and programs stored in the memory 102. The memory 102 is used for storing various types of data of the apparatus 100. The memory 102 may be an internal memory of the apparatus 100, or a removable memory. For example, the memory 102 may include, but not be limited to, random access memory (RAM), read only memory (ROM), programmable read-only memory (PROM), erasable read only memory (EPROM), electrically erasable read only memory (EEPROM) and the like.

The processor 104 may be an integrated circuit chip with signal and data processing capability. The processor 104 as described may be a general purpose processor, including a central processor (CPU), a network processor (NP) and etc. The processor 104 can also be a digital signal processor (DSP), application specific integrated circuit (ASIC), Field-programmable gate array (FPGA) or other programmable logic device, discrete gate or transistor logic, discrete hardware components. The processor 104 can execute or implement methods, steps and logic diagrams disclosed in embodiments of the present disclosure. The processor 104 may be a microprocessor or any conventional processor, etc.

The light projection module 106 may be disposed on a body of the vehicle and operable to project a visual light pattern to an external environment in which the vehicle is driving. The visual light pattern can indicate expected motions to be taken by the vehicle. When projected onto the external environment such as a ground, the visual light pattern can be observed by people around and thus the people can be well aware of the expected motions of the vehicle. In some embodiments, the light projection module 106 includes a light source and a mechanical member. The mechanical member can move to change a direction and/or focus of a light beam emitted from the light source. In this way, the light pattern from the light projection module 106 can change accordingly. In some other embodiments, the light projection module 106 can also include a power adjusting member for adjusting a power of the light beam emitted from the light source.

In some embodiments, the light projection module 106 is a digital light processing projector based on optical micro-electro-mechanical technology that uses a digital micromirror device. In the digital light processing projector, the light pattern or image is created by microscopically small mirrors laid out in a matrix on a semiconductor chip, known as a Digital Micromirror Device (DMD). The DMD is driven by a digital video or graphic signal in which each digital pixel corresponds to a single mirror on the DMD. The number of mirrors corresponds to the resolution of the projected image. These mirrors can be repositioned rapidly to reflect light either through the lens or onto a heat sink. Rapidly toggling the mirror between the two orientations produces grayscales. In an embodiment, to get color, a rotating color wheel (with red, green and blue filters) is put between the light source and the DMD. Separate signal is delivered for each of the three colors, and each mirror (i.e., each pixel) is switched on and off as the filter rotates each color between the lamp and DMD. In other embodiments, different methods may be used to create a color image, and the present disclosure is not limited thereto.

In some embodiment, the light projection module 106 includes a laser light source. The laser light source can produce a richer, more vibrant color palette than conventional light sources. In some embodiments, the light projection module 106 includes a light-emitting diode (LED) light source or an Ultra High Power (UHP) lamp.

The function device 108 may include a camera 108a, a sensor 108b and the like. The function device is used by the apparatus 100 to perform specific operations (for example, taking pictures of the external environment, telemetering with infrared, etc.). In some embodiments, the camera 108a may be used to monitor the visual light pattern projected onto the surface in the external environment, such that the processor 104 can control light projection module 106 to adjust the visual light pattern when a substantial portion of the visual light pattern is not projected onto the surface. In some examples, a substantial portion of the visual light pattern not projected onto the surface refers to that a ratio greater than 10%, 20%, 30%, 40%, 50%, 60%, 70%, 80% or 90% of an area of the visual light pattern cannot be projected onto a surface of the environment. In some other examples, a substantial portion of the visual light pattern not projected onto the surface refers to that an intensity of the visual light pattern is substantially equal to or lower than an intensity of environmental lighting such that people around cannot observe such visual light pattern. In some other examples, a substantial portion of the visual light pattern not projected onto the surface refers to that an essential part of the visual light pattern indicating the expected motion of the vehicle (such as a head of an arrow) cannot be projected onto the surface with the other part of the visual light pattern. In some embodiments, the sensor 108b may be a distance detection sensor, and is used for detecting a distance between the vehicle and an object in the external environment.

The I/O unit 110 is an interface for data transmission of the apparatus 100. In some embodiments, the I/O unit 110 may be used to receive a user's input. For example, the I/O unit 110 may include a touch screen, a button, a voice sensor for receiving the user's voice command, and/or an image capturing device for detecting the user's hand gesture or body language.

As shown in FIG. 2, the apparatus 100 may be mounted on a vehicle 200, so as to notify an expected motion of the vehicle 200. In some embodiment, the vehicle 200 is an autonomous vehicle. In some embodiments, the apparatus 100 may be integrated within an automotive lighting system, such as with a front light, of the vehicle.

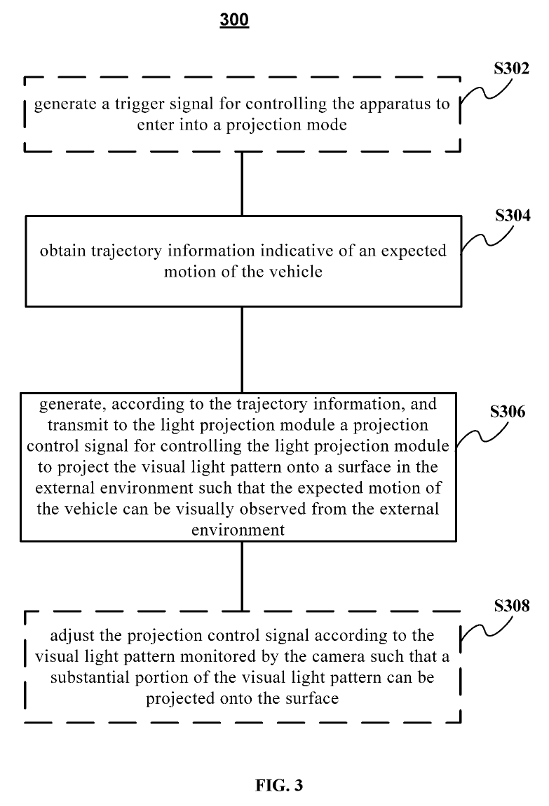

FIG. 3 is a flow chart of a method 300 for notifying an expected motion of a vehicle. In some embodiment, the memory 102 of the apparatus 100 shown in FIG. 1 stores instructions corresponding to the method 300, and by reading and executing the instructions, the processor 104 is caused or configured to perform the steps of the method 300, so as to notify an expected motion of the vehicle 200 shown in FIG. 2.

In Step S302, a trigger signal for controlling the apparatus 100 to enter into a projection mode is generated.

After the apparatus 100 has enter into the projection mode, the apparatus 100 may perform subsequent steps for notifying one or more expected motions of the vehicle. It should be noted that, in some embodiments, the projection mode is always activated, and then Step S302 may be omitted.

In some embodiments, the trigger signal is generated in response to a user input. For example, a user or driver of the vehicle may input a projection instruction to the apparatus 100. The projection instruction may be input by the user triggering a button on the apparatus 100, sending a voice command, or performing a specific action within a capturing area of an image capturing device. As to inputting the projection instruction by triggering the button, the user may press relevant button(s), and then the projection instruction can be transmitted to the processor 104 in form of an electric signal. As to inputting the projection instruction by voice control, the user may input a specific voice command (for example, “start projection”, etc.), and then the apparatus 100 can receive the voice command as the projection instruction through a microphone or the like, which picks up the voice and further converts the voice command into an electric signal. The electric signal can be further transmitted to the processor 104. As to inputting the projection instruction through the specific action (for example, a predetermined gesture, a unique hand gesture or body language, etc.), the user may perform a specific action within a capturing area, and then the image capturing device can take the acquired specific action as the projection instruction, converts the projection instruction into an electric signal, and sends the signal to the processor 104. After receiving the signal corresponding the projection instruction, the processor 104 may generate the trigger signal.

In some embodiments, the trigger signal is generated in response to a pedestrian's request. For example, an imaging device mounted on the vehicle is used to detect pedestrians' actions. If a specific gesture of a pedestrian (for example, a sweeping gesture) is detected, it can be determined that the pedestrian requests the vehicle to show its expected motions, and thus the trigger signal is generated. In some other examples, a microphone is used to detect pedestrians' voices. If a specific voice of a pedestrian is detected, it can also be determined that the pedestrian requests the vehicle to show its expected motions, and thus the trigger signal is generated.

In some embodiments, the trigger signal is generated automatically by the vehicle using a specific algorithm, which can determine specific conditions where motions of the vehicle should be visually observed from the external environment. For example, an imaging device may be used to take a picture or video of the external environment, and the trigger signal is generated when a number of objects in the external environment is greater than a predetermined number. In some embodiments, a radar may be used to detect a distance between the vehicle and an object in the external environment, the trigger signal is generated when the distance is smaller than a predetermined distance. The object in the external environment may be a vehicle, a pedestrian, a bicyclist, or the like.

In some embodiments, the trigger signal is generated when a series of car honks is received through a microphone or a voice sensor. The series of honks may be made by the vehicle equipped with apparatus 100, or other vehicle in the external environment. In some embodiments, the trigger signal is generated when a message is received from a V2X (vehicle-to-everything) mechanism running on another vehicle or infrastructure in the external environment, or a software running on a mobile device. Both the series of honks and the message may indicate that the expected motion of the vehicle should be visually observed from the external environment.

In step 304, trajectory information indicative of an expected motion of the vehicle is obtained.

The trajectory information may include an expected trajectory of the vehicle, and/or an expected turning to be made by the vehicle. It can be readily appreciated that the trajectory information may include two or more expected motions of the vehicle in a sequence.

In some embodiments, the trajectory information may be determined based on one or more parameters of the vehicle, such as a current position of the vehicle, a speed of the vehicle, a wheel track of the vehicle, and/or a steering angle of the vehicle. There parameters can be collected through a motion detecting system (e.g. an inertial sensor) of the vehicle, and then transmitted to the processor 104.

In some embodiment, the vehicle is an autonomous vehicle, and the trajectory information may be obtained from a control system of the autonomous vehicle. Generally, autonomous vehicles use a variety of technologies (such as radar, laser light, GPS, odometry and computer vision) to detect their surroundings, such that the control system can use these sensory information to plan a trajectory and a turning.

In step S306, a projection control signal is generated according to the trajectory information, and then is transmitted to the light projection module for controlling the light projection module to project the visual light pattern onto a surface in the external environment such that the expected motion of the vehicle can be visually observed from the external environment.

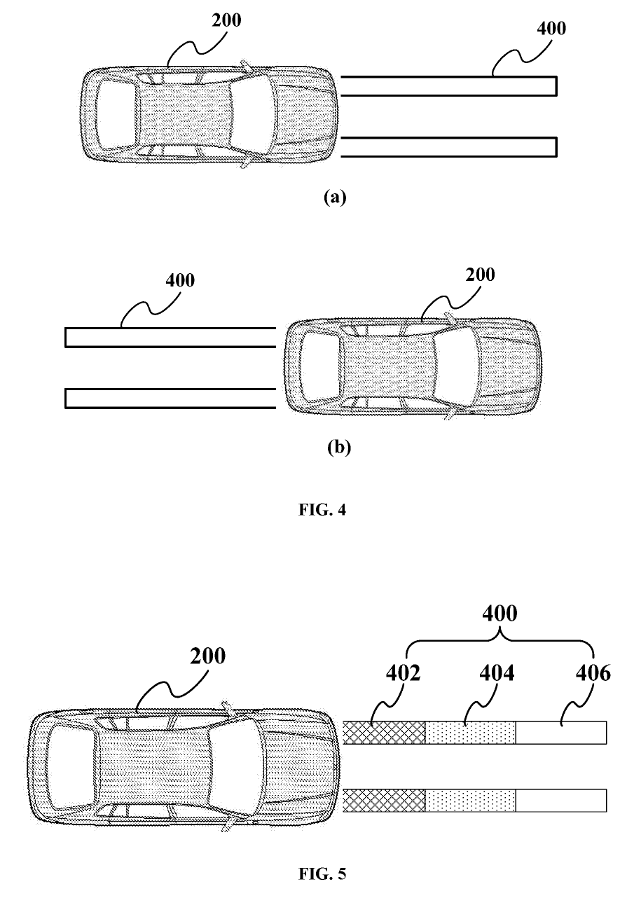

Referring to FIG. 1 and FIGS. 4a and 4b, the processor 104 may transmit the projection control signal to the light projection module 106, so as to control the light projection module 106 to project the visual light pattern 400 onto a surface in the external environment. The surface in the external environment may be a ground surface. The visual light pattern 400 indicates the expected trajectory of the vehicle 200, and/or the expected turning to be made by the vehicle 200, such that the expected motion of the vehicle 200 can be visually observed from the external environment.

In some embodiments, as shown in FIG. 4 (a), when the vehicle 200 moves forward, the light projection module 106 projects the visual light pattern 400 onto the ground in the front of the vehicle 200. In some embodiments, as shown in FIG. 4 (b), when the vehicle 200 moves backward, the light projection module 106 projects the visual light pattern 400 onto the ground in the back of the vehicle 200.

In some embodiment, the visual light pattern may include at least one portion identified with a color indicative of urgency of the expected motion of the vehicle. For example, as shown in FIG. 5, the visual light pattern 400 includes a red portion 402 indicating a region the vehicle 200 will reach in the 1^{st} second, a yellow portion 404 indicating a region the vehicle 200 will reach in the 2^{nd} second, and a green portion 406 indicating a region the vehicle 200 will reach in the 3^{rd} second. In some embodiments, the visual light pattern 400 may include a plurality of portions with different patterns or different color depths to indicate urgency of the expected motion of the vehicle 200.

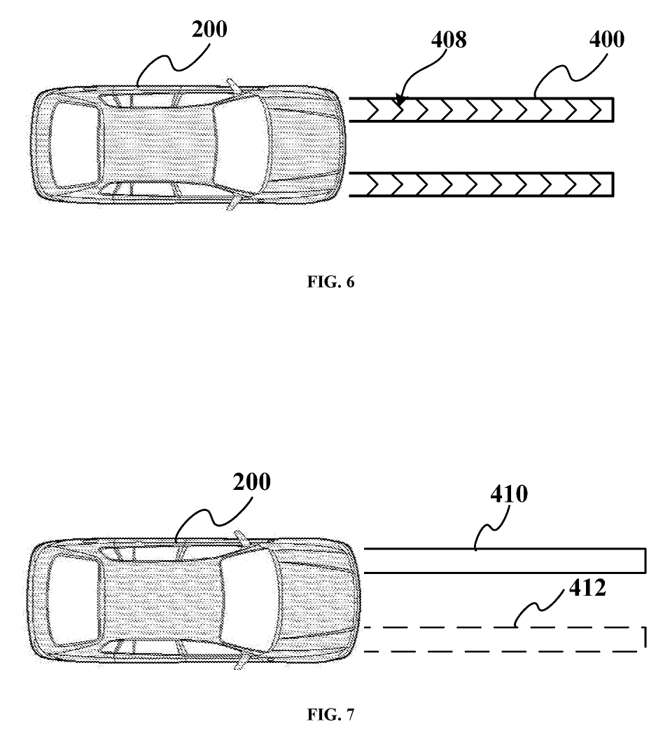

In some embodiments, the visual light pattern may include a static pattern or a dynamic pattern. For example, as shown in FIG. 6, the visual light pattern 400 includes a plurality of dynamic symbols 408. The plurality of dynamic symbols 408 can be used to indicate the expected trajectory and driving direction of the vehicle 200. FIG. 7 also shows a dynamic light pattern. As shown in FIG. 7, the visual light pattern includes a left portion 410 and a right portion 412. The left portion 410 is a static pattern, while the right portion 412 is a dynamic patter. The right portion 412 flickers to indicate that the vehicle will turn right soon.

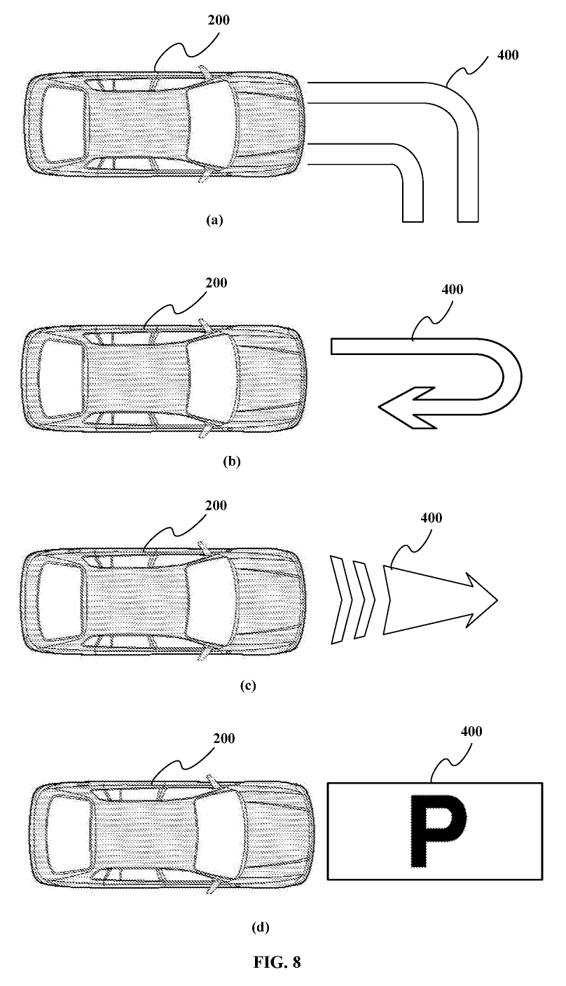

FIG. 8 (a)-(d) illustrate more examples of the visual light pattern. The visual light pattern has different shapes to indicate different motions that the vehicle will make in the short term. As shown in FIG. 8 (a), the visual light pattern 400 includes a curved trajectory to indicate the expected turning to be made by the vehicle 200. As shown in FIG. 8 (b), the visual light pattern 400 includes a reversing trajectory to indicate that the vehicle 200 will turn around soon. As shown in FIG. 8 (c), the visual light pattern 400 includes a forward arrow to indicate that the vehicle 200 will speed up. As shown in FIG. 8 (d), the visual light pattern 400 includes a parking sign to indicate that the vehicle 200 will stop soon.

Various example of the visual light pattern have been described herein with reference to the accompanying drawings. However, persons of ordinary skill in the art will recognize that the visual light pattern may have other features as required without departing from the spirit or scope of the present disclosure.

Referring to FIG. 3, in step S308, the projection control signal may be adjusted according to the visual light pattern monitored by a camera.

In some embodiments, if a manhole cover or an obstacle lies in the expected trajectory of the vehicle 200, the visual light pattern projected on the ground surface would be incomplete or distorted. In this context, the camera 108a shown in FIG. 1 may be used to monitor the visual light pattern projected onto the ground surface. If the processor 104 determines that the visual light pattern monitored by the camera 108a is incomplete or distorted, i.e. a substantial portion of the visual light pattern cannot be projected as desired, the processor 104 may adjust the projection control signal such that the substantial portion of the visual light pattern can be projected onto the surface.

In some examples, a substantial portion of the visual light pattern not projected onto the surface refers to that a ratio greater than 10%, 20%, 30%, 40%, 50%, 60%, 70%, 80% or 90% of an area of the visual light pattern cannot be projected onto a surface of the environment. In this case, the processor 104 may adjust the projection control signal, such that the light projection module 106 is controlled to change the scale of the visual light pattern or project the visual light pattern onto other regions of the ground surface.

In some other examples, a substantial portion of the visual light pattern not projected onto the surface refers to that an intensity of the visual light pattern is substantially equal to or lower than an intensity of environmental lighting such that people around cannot observe such visual light pattern. In this case, the processor 104 may adjust the projection control signal, such that the light projection module 106 is controlled to increase the intensity of the visual light pattern or increase the contrast of the visual light pattern.

In some other examples, a substantial portion of the visual light pattern not projected onto the surface refers to that an essential part of the visual light pattern indicating the expected motion of the vehicle (such as a head of an arrow) cannot be projected onto the surface with the other part of the visual light pattern. In this case, the processor 104 may adjust the projection control signal, such that the light projection module 106 is controlled to change the shape of the visual light pattern or project the essential part of the visual light pattern onto other regions of the ground surface.

It should be noted, in some embodiments, even though there is a manhole cover or an obstacle lies in the expected trajectory of the vehicle, the portion of the visual light pattern projected on the manhole cover or the obstacle can be visually observed from the external environment. In this case, Step S308 may be omitted.

It should be noted that, the apparatus and methods disclosed in the embodiments of the present disclosure can be implemented by other ways. The aforementioned apparatus and method embodiments are merely illustrative. For example, flow charts and block diagrams in the figures show the architecture and the function operation according to a plurality of apparatus, methods and computer program products disclosed in embodiments of the present disclosure. In this regard, each frame of the flow charts or the block diagrams may represent a module, a program segment, or portion of the program code. The module, the program segment, or the portion of the program code includes one or more executable instructions for implementing predetermined logical function. It should also be noted that in some alternative embodiments, the function described in the block can also occur in a different order as described from the figures. For example, two consecutive blocks may actually be executed substantially concurrently. Sometimes they may also be performed in reverse order, depending on the functionality. It should also be noted that, each block of the block diagrams and/or flow chart block and block combinations of the block diagrams and/or flow chart can be implemented by a dedicated hardware-based systems execute the predetermined function or operation or by a combination of a dedicated hardware and computer instructions.

If the functions are implemented in the form of software modules and sold or used as a standalone product, the functions can be stored in a computer readable storage medium. Based on this understanding, the technical nature of the present disclosure, part contributing to the prior art, or part of the technical solutions may be embodied in the form of a software product. The computer software product is stored in a storage medium, including several instructions to instruct a computer device (may be a personal computer, server, or network equipment) to perform all or part of the steps of various embodiments of the present. The aforementioned storage media include: U disk, removable hard disk, read only memory (ROM), a random access memory (RAM), floppy disk or CD-ROM, which can store a variety of program codes.

Various embodiments have been described herein with reference to the accompanying drawings. It will, however, be evident that various modifications and changes may be made thereto, and additional embodiments may be implemented, without departing from the broader scope of the invention as set forth in the claims that follow.

Further, other embodiments will be apparent to those skilled in the art from consideration of the specification and practice of one or more embodiments of the invention disclosed herein. It is intended, therefore, that this disclosure and the examples herein be considered as exemplary only, with a true scope and spirit of the invention being indicated by the following listing of exemplary claims.

What is claimed is:

1. An apparatus for notifying an expected motion of a vehicle, comprising:
a light projection module disposed on a body of the vehicle and operable to project a visual light pattern to an external environment in which the vehicle is driving; and
a processor configured to:
obtain trajectory information indicative of an expected motion of the vehicle; and
generate, according to the trajectory information, and transmit to the light projection module a projection control signal for controlling the light projection module to project the visual light pattern onto a surface in the external environment such that the expected motion of the vehicle can be visually observed from the external environment.

2. The apparatus of claim 1, wherein the light projection module comprises a laser light source, a light-emitting diode (LED) light source, or an Ultra High Power (UHP) lamp.

3. The apparatus of claim 1, wherein the trajectory information comprises: an expected trajectory of the vehicle, and/or an expected turning to be made by the vehicle.

4. The apparatus of claim 1, wherein the processor is further configured to generate a trigger signal for controlling the apparatus to enter into a projection mode, and in the projection mode, the processor is configured to obtain the trajectory information and generate the projection control signal.

5. The apparatus of claim 4, wherein the trigger signal is generated in response to a user input.

6. The apparatus of claim 4, wherein the trigger signal is generated when a distance between the vehicle and an object in the external environment is smaller than a predetermined distance, or when a number of objects in the external environment is greater than a predetermined number, and the object in the external environment is a vehicle, a pedestrian or a bicyclist.

7. The apparatus of claim 1, wherein the visual light pattern comprises a static pattern and/or a dynamic pattern.

8. The apparatus of claim 1, wherein the visual light pattern comprises at least one portion identified with a color indicative of urgency of the expected motion of the vehicle.

9. The apparatus of claim 1, further comprising:
a camera for monitoring the visual light pattern projected onto the surface; and wherein the processor is further configured to adjust the projection control signal according to the visual light pattern monitored by the camera.

10. The apparatus of claim 9, wherein the processor is further configured to adjust the projection control signal according to the visual light pattern monitored by the camera such that a substantial portion of the visual light pattern can be projected onto the surface.

11. The apparatus of claim 1, wherein the surface in the external environment is a ground surface.

12. A vehicle, comprising:
a body;
a light projection module disposed on the body of the vehicle and operable to project a visual light pattern onto an external environment in which the vehicle is driving; and
a processor configured to:
obtain trajectory information indicative of an expected motion of the vehicle; and
generate, according to the trajectory information, a projection control signal for controlling the light projection module to project the visual light pattern onto a surface in the external environment such that the expected motion of the vehicle can be visually observed from the external environment.

13. The vehicle of claim 12, wherein the vehicle is an autonomous vehicle.

14. A method for notifying an expected motion of a vehicle, comprising:
obtaining trajectory information indicative of an expected motion of the vehicle; and
generating, according to the trajectory information, and transmitting to the light projection module a projection control signal for controlling a light projection module to project a visual light pattern onto a surface in an external environment in which the vehicle is driving such that the expected motion of the vehicle can be visually observed from the external environment.

15. The method of claim 14, wherein the trajectory information comprises: an expected trajectory of the vehicle, and/or an expected turning to be made by the vehicle.

16. The method of claim 14, further comprising: generating a trigger signal for controlling the vehicle to enter into a projection mode, wherein the trajectory information is obtained and the projection control signal is generated in the projection mode.

17. The method of claim 16, wherein the trigger signal is generated in response to a user input.

18. The method of claim 16, wherein the trigger signal is generated when a distance between the vehicle and an object in the external environment is smaller than a predetermined distance, or when a number of objects in the external environment is greater than a predetermined number, and the object in the external environment is a vehicle, a pedestrian or a bicyclist.

19. The method of claim 14, wherein the visual light pattern comprises a static pattern and/or a dynamic pattern, and/or the visual light pattern comprises at least one portion identified with a color indicative of urgency of the expected motion of the vehicle.

20. The method of claim 14, further comprising: adjusting the projection control signal according to the visual light pattern monitored by a camera such that a substantial portion of the visual light pattern can be projected onto the surface.
